(19) United States
(12) Patent Application Publication
(10) Pub. No.: US 2009/0127243 A1
(43) Pub. Date: May 21, 2009

(54) Method for bonding glassy metals using electric arc

(75) Inventors: Shing-Hoa Wang, Keelung (TW); Pei-Hung Kuo, Keelung (TW); Yu-Lon Lin, Tao-Yuan (TW); Hsiao-Tsung Tsang, Taoyuan (TW); Po-Kay Chiu, Hsinchu (TW); Hung-Yin Tsai, Hsin-Chu (TW)

Correspondence Address: MORGAN LEWIS & BOCKIUS LLP, 1111 PENNSYLVANIA AVENUE NW, WASHINGTON, DC, 20004, US

(73) Assignee: National Taiwan Ocean University, Keelung (TW)

(21) Appl. No.: 12/068,341

(22) Filed: Feb. 5, 2008

(30) Foreign Application Priority Data
Nov. 21, 2007 (TW) 096144065

(51) Int. Cl. B23K 9/00

(52) U.S. Cl. 219/137 R

(57) ABSTRACT

A method for bonding two pieces of a glassy metal includes:(a) partially immersing the two pieces of the glassy metal in a liquid cooling medium; and (b) welding the two pieces of the glassy metal, which are cooled by the cooling medium at the same time, using pulsed electric arc techniques. The cooling medium provides a cooling rate that is sufficient to prevent crystallization in melted portions of the two pieces of the glassy metal from occurring during welding.

### CROSS-REFERENCE TO RELATED APPLICATION

This application claims priority of Taiwanese application no. 096144065, filed on Nov. 21, 2007.

### BACKGROUND OF THE INVENTION

1. Field of the Invention

This invention relates to a method for bonding two pieces of a glassy metal, more particularly to a method involving partially immersing the two pieces of the glassy metal in a cooling medium during welding.

2. Description of the Related Art

A glassy metal is an amorphous material that exhibits excellent properties, such as high strength, high hardness, high flexibility, high resistance to corrosion and high ferromagnetism.

Conventional methods for bonding small size glassy metal pieces into a large unit include electron beam welding techniques and friction welding techniques. Laser beam welding techniques involve applying a laser to heat the glassy metal pieces above a melting point of the glassy metal so as to fuse them together. Friction welding techniques involve using friction to bond the pieces of the glassy metal together. However, electron beam welding and laser beam welding are relatively expensive, and friction welding is required to be conducted under a relatively high pressure and high cost of equipment during the welding process. In addition, these techniques might produce undesired crystallization in welding portions of the pieces during bonding.

### SUMMARY OF THE INVENTION

Therefore, the object of the present invention is to provide a method for bonding two pieces of a glassy metal that can overcome the aforesaid drawbacks associated with the prior art.

According: to the present invention, the method for bonding two pieces of a glassy metal comprises: (.a) partially immersing the two pieces of the glassy metal in a liquid cooling medium; and (b) welding the two pieces of the glassy metal, which are cooled by the cooling medium at the same time, using pulsed electric arc techniques. The cooling medium provides a cooling rate- that is sufficient to prevent crystallization in melted portions of the two pieces of the glassy metal from occurring during welding.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a perspective view showing how two pieces of a glassy metal are bonded together in an operating step of the preferred embodiment of a method according to the invention;

FIG. 2 is a Differential Scanning Calorimetry diagram of the glassy metal used in the preferred embodiment;

FIG. 3 is a continuous cooling kinetic transformation diagram showing a critical cooling rate of the glassy metal used in the preferred embodiment;

FIG. 4 is a plot showing a temperature/time relation for determining a cooling rate of a cooling medium used in the preferred embodiment;

FIG. 5 is a macro-image showing a cross section of a welded portion of the pieces of the glassy metal bonded together according to the preferred embodiment;

FIG. 6 is an X-ray diffraction graph of the welded portion of the pieces of the glassy metal bonded together according to the preferred embodiment; and

FIG. 7 is a backscattered electron image showing no sign of crystallization occurred on the welded portion of the pieces of the glassy metal bonded together according to the preferred embodiment.

### DETAILED DESCRIPTION OF THE PREFERRED EMBODIMENT

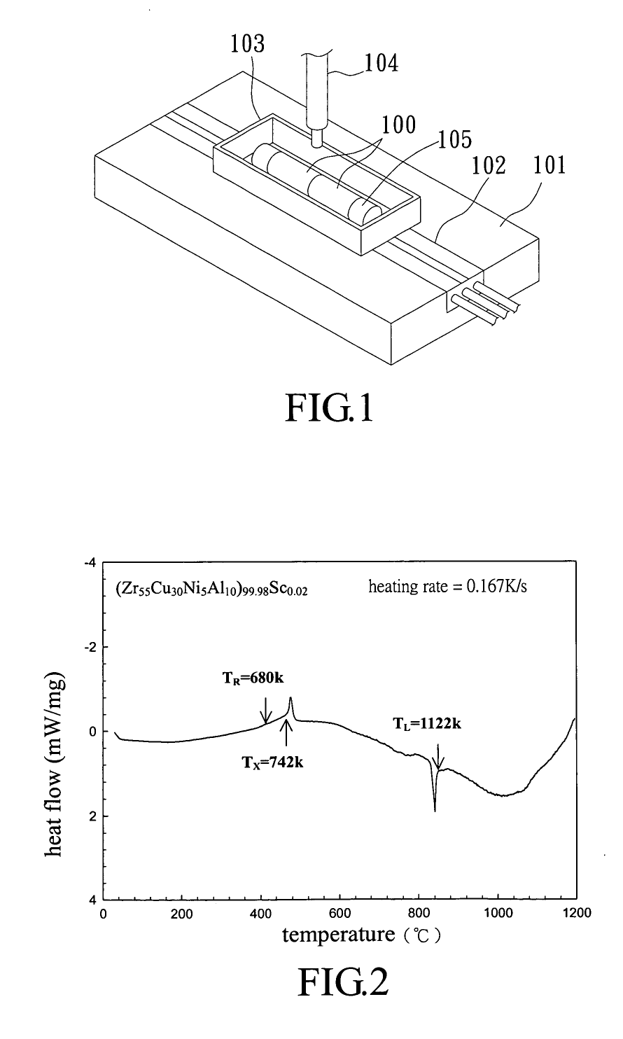

FIG. 1 illustrates an apparatus used in the preferred embodiment of a method for bonding two rod-like pieces 100 of a glassy metal according to this invention.

The method includes: (a) partially immersing the two pieces 100 of the glassy metal in a liquid cooling medium; and (b) welding the two pieces 100 of the glassy metal, which are cooled by the cooling medium at the same time, using pulsed electric arc techniques. The cooling medium provides a cooling rate that is sufficient to prevent crystallization in melted portions of the two pieces 100 of the glassy metal from occurring during welding.

Preferably, the method further includes identifying a critical cooling rate of the glassy metal, below which the melt of the glassy metal undergoes crystallization during cooling.

In this embodiment, the glassy metal is Sc-Zirconium based glassy metal having a composition represented by the formula: (Zr₅₅Cu₃₀Ni₅Al₁₀)₁₀₀₋ₓScₓ, x is in atomic percent and 0.01≦x≦2.

Preferably, the cooling rate provided by the cooling medium is greater than 200K/s.

Preferably, the temperature difference between the glass transition temperature (T_{g}) and the crystallization temperature (Tₓ) of the Sc-Zirconium based glassy metal is not less than 62K.

Preferably, the temperature difference between the glass transition temperature (T_{g}) and the melting point (Tₘ) of the Sc-Zirconium based glassy metal is not larger than 442K.

Preferably, the Sc-Zirconium based glassy metal has a glass forming ability γ represented by the formula: γ=Tₓ/(T_{g}+Tₘ) (definition of the glass forming ability γ can be found in the publication by Z. P. Lu, C. T. Liu, Intermetallics, 2004, 12, 1035 and Z. P. Lu, C. T. Liu, Acta Mater., 2002, 50, 3501), and is not less than 0.42.

Preferably, the Sc-Zirconium based glassy metal has a glass forming ability γₘ represented by the formula: γₘ=(2Tₓ−T_{g}/Tₘ) (definition of the glass forming ability γₘ can be found in the publication by X. H. Du, J. C. Huang, C. T. Liu, and Z. P. Lu, J. Appl. Phys., 2007, 101, 086108), and is not less than 0.72.

In this embodiment, the pulsed electric arc technique is gas tungsten arc welding technique.

The merits of the method of this invention will become apparent with reference to the following Example.

### EXAMPLE

The two pieces 100 of the glassy metal made from (Zr₅₅Cu₃₀Ni₅Al₁₀)_{99.98}SC_{0.02} having a diameter of 5 mm and a length of 8-10 cm were placed in a box 103 seated on a copper seat 102 embedded in an aluminum-made holder 101. A chilled water flow having a temperature of 5° C. was circulated through the copper seat 102. Two sacrificial glassy metal pieces 105 were installed in the box 103 to respectively abut against the two pieces 100 of the glassy metal. The cooling medium of liquid nitrogen was added into the box 103 to a level so as to partially immerse the two pieces 100 of the glassy metal therein.

A welding torch 104 was subsequently applied on the contacting interface of the two pieces 100 of the glassy metal under the following welding conditions: the range of peak current of the welding torch was 15-25 ampere; the background current was less than 1 ampere, and the average voltage was within the range of 15-25 volts. The moving speed of the welding torch was less than 2 cm/s. Liquid nitrogen was replenished during welding so as to prevent crystallization in the melted portions of the two pieces 100 of the glassy metal from occurring. The temperature in the chamber was measured by a R-type thermocouple.

The glass transition temperature, the crystallization temperature and the melting point of the (Zr₅₅Cu₃₀Ni₅Al₁₀)_{99.98}Sc_{0.02} were 680K, 742K and 1122K, respectively, as measured by a Differential Scanning Calorimetry Instrument (see FIG. 2).

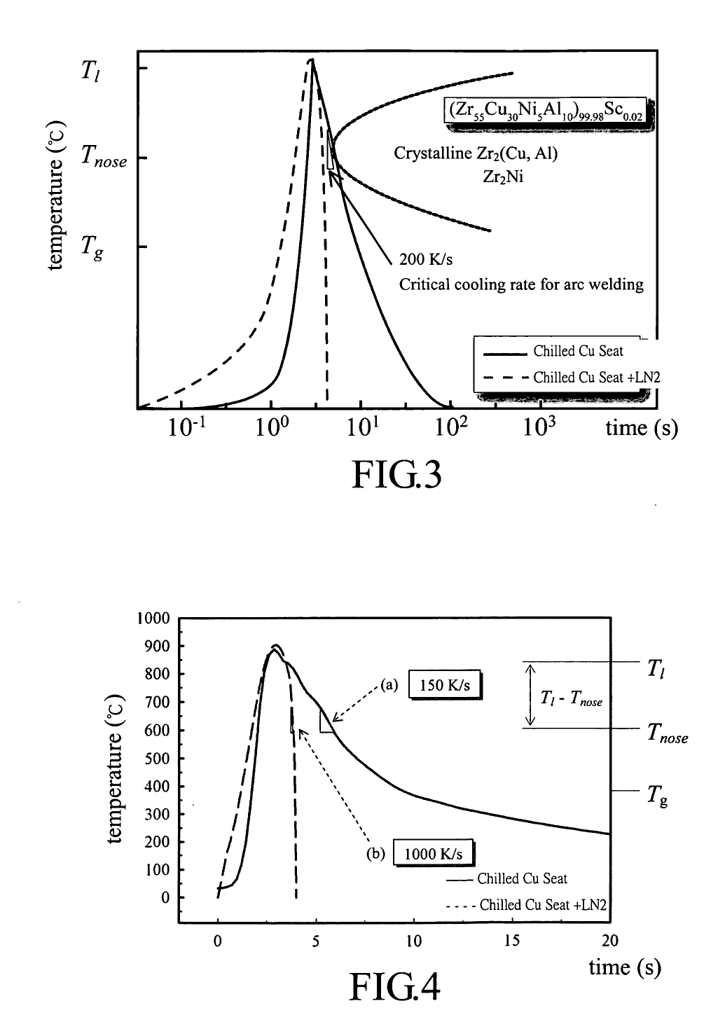

FIG. 3 is a continuous cooling kinetic transformation diagram (C-curve) showing that the critical cooling rate of the (Zr₅₅Cu₃₀Ni₅Al₁₀)_{99.98}Sc_{0.02} was 200K/s just at a nose point of the C-curve.

FIGS. 3 and 4 show the cooling rates for the cooling medium of solely chilled copper seat 102 and the cooling medium of liquid nitrogen aided by the chilled copper seat 102, respectively. With the chilled copper seat 102, the cooling rate was 150K/s, which was below the critical cooling rate (200K/s) and was insufficient to prevent crystallization from occurring. With the liquid nitrogen aided by the chilled copper seat 102, the cooling rate was up to 1000K/s, which was above the critical cooling rate (200K/s), and was sufficient to prevent crystallization of the glassy metal from occurring (see FIG. 5).

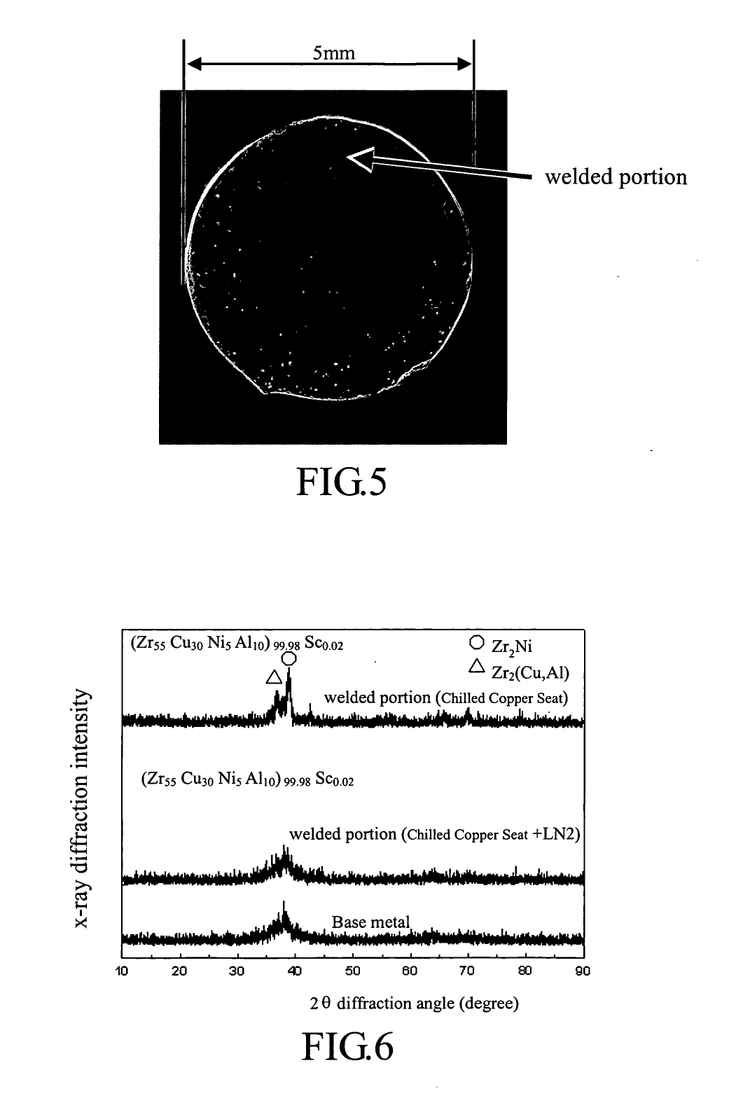

FIG. 6 is an X-ray diffraction graph showing the compositions of welded portions of the two pieces 100 of the glassy metal for the cooling medium of solely chilled copper seat 102 and the cooling medium of liquid nitrogen aided by the chilled copper seat 102. Peaks of Zr₂Ni and Zr₂(Cu,Al) crystals were found in the solely chilled copper seat 102 cooling, while no peaks of the crystals were found in the liquid nitrogen aided by the chilled copper seat 102 cooling.

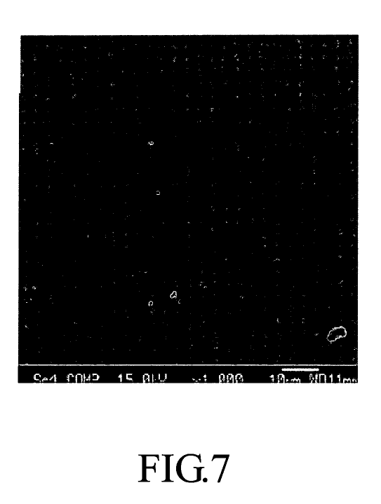

FIG. 7 is a backscattered electron image of welded portion, which was analyzed by Field Emission-Electron Probe Microanalyzer (FE-EPMA), when the liquid nitrogen aided by the chilled copper seat 102 was used as the cooling medium. The result shows that no crystallization occurred at the welded portion during the welding operation in the Example.

It has thus been shown that, by providing the cooling rate above the critical cooling rate of the glassy metal during welding and cooling operation, the aforesaid drawbacks associated with the prior art can be eliminated.

With the invention thus explained, it is apparent that various modifications and variations can be made without departing from the spirit of the present invention. It is therefore intended that the invention be limited only as recited in the appended claims.

What is claimed is:

1. A method for bonding two pieces of a glassy metal, comprising:
(a) partially immersing the two pieces of the glassy metal in a liquid cooling medium; and
(b) welding the two pieces of the glassy metal, which are cooled by the cooling medium at the same time, using pulsed electric arc techniques;
wherein the cooling medium provides a cooling rate that is sufficient to prevent crystallization in melted portions of the two pieces of the glassy metal from occurring during welding.

2. The method of claim 1, further comprising identifying a critical cooling rate of the glassy metal, below which the melt of the glassy metal undergoes crystallization during cooling.

3. The method of claim 1, wherein the glassy metal is Sc-Zirconium based glassy metal.

4. The method of claim 3, wherein the glassy metal has a composition represented by the formula:
(ZrS₅Cu₃₀Ni₅Al₁₀)₁₀₀₋ₓScₓ, x is in atomic percent and 0.01≦
x≦2.

5. The method of claim 4, wherein the cooling rate provided by the cooling medium is greater than 200K/s.

6. The method of claim 5, wherein the temperature difference between the glass transition temperature and the crystallization temperature of the glassy metal is not less than 62K.

7. The method of claim 6, wherein the temperature difference between the glass transition temperature and the melting point of the glassy metal is not larger than 442K.

8. The method of claim 4, wherein the glassy metal has a glass forming ability γ not less than 0.42.

9. The method of claim 4, wherein the glassy metal has a glass forming ability γₘ not less than 0.72.
